(19) United States
(12) Patent Application Publication
(10) Pub. No.: US 2026/0155307 A1
(43) Pub. Date: Jun. 4, 2026

(54) MULTILAYER CERAMIC CAPACITOR AND METHOD OF PREPARING THE SAME

(71) Applicant: SAMSUNG ELECTRO-MECHANICS CO., LTD., Suwon-si, Gyeonggi-do (KR)

(72) Inventors: Daewoo Yoon, Suwon-si, Gyeonggi-do (KR); Bumsuk Kang, Suwon-si, Gyeonggi-do (KR); Da Mi Kim, Suwon-si, Gyeonggi-do (KR); Jaehoon Bang, Suwon-si, Gyeonggi-do (KR); Sujin Lee, Suwon-si, Gyeonggi-do (KR); Junghyun Kim, Suwon-si, Gyeonggi-do (KR); Wansik Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 19/091,531

(22) Filed: Mar. 26, 2025

(30) Foreign Application Priority Data
Dec. 2, 2024 (KR) 10-2024-0176229

(51) Int. Cl. H01G 4/232; H01G 4/008; H01G 4/12; H01G 4/248; H01G 4/30; H01G 13/00

(52) U.S. Cl. CPC H01G 4/2325; H01G 4/008; H01G 4/1227; H01G 4/248; H01G 4/30; H01G 13/006

(57) ABSTRACT

A multilayer ceramic capacitor may include a capacitor body including a dielectric layer and an internal electrode layer, and an external electrode located on an outer side of the capacitor body, and including a conductive metal and glass, where the glass may include a first interface region in contact with the conductive metal, and where the first interface region may include at least one of Ag or Pd.

### CROSS-REFERENCE TO RELATED APPLICATION

This application claims priority to and the benefit of Korean Patent Application No. 10-2024-0176229 filed with the Korean Intellectual Property Office on Dec. 2, 2024, the entire contents of which is incorporated herein by reference.

### BACKGROUND

### (a) Field

The present disclosure relates to a multilayer ceramic capacitor and a method of preparing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the miniaturization of electronic products, multilayer ceramic capacitors are also required to be miniaturized and to have ultra-high capacitance. To this end, the thickness of the dielectric layer and internal electrode layer is reduced, and a multilayer ceramic capacitor having a structure in which a greater number of dielectric layers and internal electrode layers are stacked is being developed. These ultra-small and ultra-high-capacitance multilayer ceramic capacitors are recently used in fields that require a high level of reliability, such as electric vehicles, and accordingly, high reliability is required for such capacitors.

### SUMMARY

According to one aspect of the present disclosure, a multilayer ceramic capacitor with improved reliability and low-resistance characteristics may be provided.

According to another aspect of the present disclosure, a method of preparing a multilayer ceramic capacitor with improved reliability and low-resistance characteristics may be provided.

However, the objective of the present disclosure is not limited to the aforementioned embodiments, and may be extended in various ways within the spirit and scope of the present disclosure.

A multilayer ceramic capacitor may include a capacitor body including a dielectric layer and an internal electrode layer, and an external electrode located on an outer side of the capacitor body, and including a conductive metal and glass, where the glass may include a first interface region in contact with the conductive metal, and where the first interface region may include at least one of Ag or Pd.

The first interface region may be defined as a region of a depth of 500 nm from an interface of the conductive metal and the glass in an inward direction of the glass.

The glass may further include a second interface region in contact with the internal electrode layer, and the second interface region may include the at least one of Ag or Pd.

The second interface region may be defined as a region of a depth of 500 nm from an interface of the glass and the internal electrode layer in an inward direction of the glass.

The second interface region may include an alloy including Ni, and at least one of Ag or Pd.

The second interface region may further include at least one of Fe, Co, or In.

The first interface region may further include oxide of the conductive metal.

The first interface region may include the conductive metal, and an alloy including the at least one of Ag or Pd.

The glass may further include a central region in which a depth from an interface of the conductive metal and the glass in an inward direction of the glass exceeds 500 nm, and the central region may include the at least one of Ag or Pd.

The central region may further include at least one of Fe, Co, or In.

The glass may further include at least one selected from the group consisting of Si, Al, Fe, Sn, Zn, Li, Na, K, Ba, Ca, Sr, B, Ni, Mn, Ge, Cu, In, Co, Ti, and P.

The external electrode may include an electrode layer electrically connected to the internal electrode layer and located on a cross-section of the capacitor body, and the electrode layer may include the conductive metal and the glass.

The conductive metal may include at least one selected from the group consisting of Cu, Ni, Au, Pt, Sn, W, Ti and Pb.

A multilayer ceramic capacitor may include a capacitor body including a dielectric layer and an internal electrode layer, and an external electrode located on an outer side of the capacitor body, and including a conductive metal including Cu and glass, where the glass may include at least one of Ag or Pd.

The glass may include a first interface region in contact with the conductive metal, and the first interface region may include the at least one of Ag or Pd.

The glass may further include a second interface region in contact with the internal electrode layer, and the second interface region may include the at least one of Ag or Pd.

The glass may further include a central region in which a depth from an interface of the conductive metal and the glass in an inward direction of the glass exceeds 500 nm, and the central region may include the at least one of Ag or Pd.

A method of preparing a multilayer ceramic capacitor, the method includes applying a paste for forming an electrode layer including a conductive metal and a glass composition on a first surface of a capacitor body including a dielectric layer and an internal electrode layer, and forming the electrode layer of an external electrode by sintering the paste for forming an electrode layer, where the glass composition may include at least one selected from a group consisting of Ag oxide and Pd oxide.

A content of the at least one selected from a group consisting of Ag oxide and Pd oxide among a total weight of the glass composition may be 0.01 wt % to 15 wt %.

The glass composition may further include at least one selected from a group consisting of Si oxide, Al oxide, Fe oxide, Sn oxide, Zn oxide, Li oxide, Na oxide, K oxide, Ba oxide, Ca oxide, Sr oxide, B oxide, Ni oxide, Mn oxide, Ge oxide, Cu oxide, In oxide, Co oxide, Ti oxide, and P oxide.

According to an example of the present disclosure, the adhesive strength between a conductive metal and glass included in an external electrode and the density of the external electrode may be improved, the reliability and structural stability of the multilayer ceramic capacitor may be improved.

According to another example of the present disclosure, the connectivity and low-resistance characteristics of the internal electrode layer and the glass 12 included in the external electrode may be further improved, and the reliability and structural stability of the multilayer ceramic capacitor may be further improved.

### BRIEF DESCRIPTION OF THE DRAWINGS

FIG. 1 is a perspective view showing a multilayer ceramic capacitor according to an example.

FIG. 2 is a cross-sectional view of a multilayer ceramic capacitor taken along line I-I′ of FIG. 1.

FIG. 3 is a cross-sectional view of a multilayer ceramic capacitor taken along line II-II′ of FIG. 1.

FIG. 4 is an enlarged partial cross-sectional view of the portion A of FIG. 2.

FIG. 5 is a graph showing the equivalent series resistance (ESR) of the multilayer ceramic capacitor according to Example 7 and Comparative Example 7.

### DETAILED DESCRIPTION OF THE EMBODIMENTS

The present disclosure will be described more fully hereinafter with reference to the accompanying drawings, in which embodiments of the disclosure are shown. In order to clearly describe the present disclosure, parts or portions that are irrelevant to the description are omitted, and identical or similar constituent elements throughout the specification are denoted by the same reference numerals. Further, some constituent elements in the drawings may be exaggerated, omitted, or schematically illustrated, and a size of each constituent element does not reflect the actual size entirely.

Further, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including ordinal numbers such as first, second, and the like will be used only to describe various components, and are not interpreted as limiting these components. The terms are only used to differentiate one component from others.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

It will be further understood that terms “comprise” and “have” used in the present specification specify the presence of stated features, numerals, steps, operations, components, parts, or combinations thereof, but do not preclude the presence or addition of one or more other features, numerals, steps, operations, components, parts, or combinations thereof. In addition, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

In addition, throughout the specification, “connected” means that two or more components are not only directly connected, but two or more components may be connected indirectly through other components, physically connected as well as being electrically connected, or it may be referred to by different names depending on the location or function, but may mean integral.

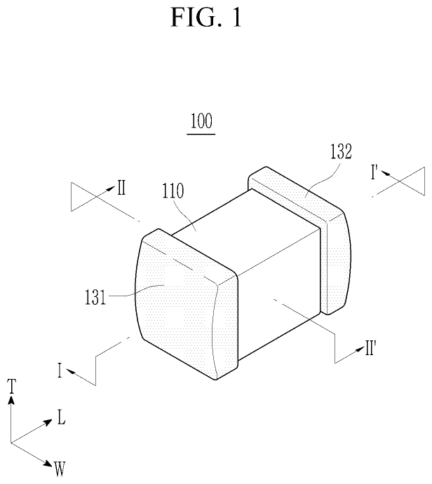

Hereinafter, a multilayer ceramic capacitor according to an example of the present disclosure will be described with reference to FIG. 1 to FIG. 3.

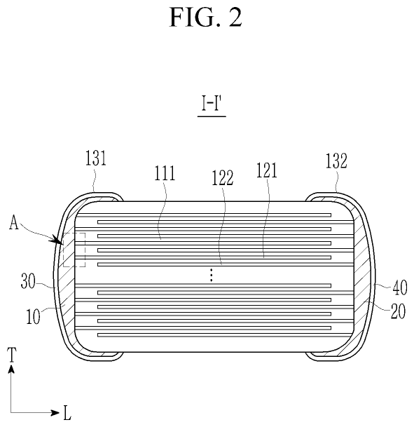

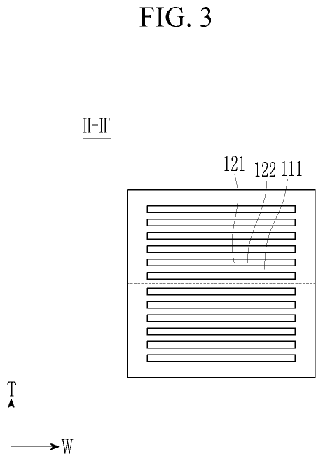

FIG. 1 is a perspective view conceptually showing a multilayer ceramic capacitor according to an example. FIG. 2 is a conceptual cross-sectional view of a multilayer ceramic capacitor taken along line I-I′ of FIG. 1. FIG. 3 is a conceptual cross-sectional view of a multilayer ceramic capacitor taken along line II-II′ of FIG. 1.

Referring to FIG. 1 to FIG. 3, a multilayer ceramic capacitor 100 may include a capacitor body 110 and external electrodes 131 and 132 disposed on an outer side of the capacitor body 110. The external electrodes 131 and 132 may include a first external electrode 131 and a second external electrode 132 disposed at both ends facing each other in a length direction (L-axis direction) of the capacitor body 110.

The L-axis, W-axis and T-axis shown in FIG. 1 to FIG. 3 represent a length direction, a width direction, and a stacking direction of the capacitor body 110, respectively. Here, the stacking direction (T-axis direction) may be a direction perpendicular to wide surfaces (major surfaces) of the sheet-shaped components, and as an example, may be used as the same concept as a stacking direction in which a dielectric layer 111 is stacked. The length direction (L-axis direction) may be a direction generally perpendicular to the stacking direction (T-axis direction) in a direction extending parallel to wide surfaces (major surfaces) of the sheet-shaped components, and as an example, may be a direction in which the first external electrode 131 and the second external electrode 132 are located on both sides. The width direction (W-axis direction) may be a direction generally perpendicular to the stacking direction (T-axis direction) and the length direction (L-axis direction) in a direction extending parallel to wide surfaces (major surfaces) of the sheet-shaped components, and lengths of the sheet-shaped components in the length direction (L-axis direction) may be greater than the lengths in the width direction (W-axis direction).

In an example, the capacitor body 110 may include a generally hexahedral shape.

Hereinafter, for convenience of description, in the capacitor body 110, both surfaces facing each other in the stacking direction (T-axis direction) may be defined as a first surface and a second surface, both surfaces connected to the first surface and the second surface and facing each other in the length direction (L-axis direction) may be defined as a third surface and a fourth surface, both surfaces connected to the first surface and the second surface, connected to the third surface and the fourth surface, and facing each other in the width direction (W-axis direction) may be defined as a fifth surface and a sixth surface.

The first surface, which is a lower surface of the capacitor body 110, may be a surface facing a mounting direction of the multilayer ceramic capacitor 100. At least one of the first surface to the sixth surface may be flat. Alternatively, at least one of the first surface to the sixth surface may be a curved surface with a convex central portion, and an edge, which is a boundary of each surface may be rounded.

The shape and size of the capacitor body 110 and the number of stacks of the dielectric layer 111 are not limited to what is illustrated in the drawings of the present disclosure.

The capacitor body 110 may include the dielectric layer 111 and internal electrode layers 121 and 122. The capacitor body 110 may include a plurality of dielectric layers 111.

The capacitor body 110 may include a first internal electrode 121 and a second internal electrode 122 alternately disposed in the stacking direction (T-axis direction) interposing the plurality of dielectric layers 111, and the dielectric layer 111.

Boundaries between adjacent dielectric layers 111 may be integrated to the degree that it may be difficult to confirm without using scanning electron microscopy (SEM).

The capacitor body 110 may include an active region. The active region may be a portion that contributes to forming the capacitance of the multilayer ceramic capacitor 100. For example, the active region may be a region where the first internal electrode 121 or the second internal electrode 122 stacked along the stacking direction (T-axis direction) overlap with each other.

The capacitor body 110 may further include a cover region and a side margin region.

The cover region is a marginal portion in the stacking direction, and may be located to be adjacent to the first surface and the second surface of the active region in the stacking direction (T-axis direction), respectively. For example, a single dielectric layer 111 or two or more the dielectric layers 111 may be stacked on an upper surface and a lower surface of the active region, respectively, to be provided as the cover region.

The side margin region is a marginal portion in the width direction, and may be located to be adjacent to the fifth surface and the sixth surface of the active region in the width direction (W-axis direction), respectively. The side margin region may be formed by stacking dielectric green sheets in which a conductive paste layer is applied to only a partial region of the dielectric green sheet surface, and the conductive paste layer is not applied to both side surfaces of the dielectric green sheet surface, and then firing it.

For example, through the cover region and the side margin region, the damage of the first internal electrode 121 and the second internal electrode 122 due to physical or chemical stress may be prevented.

The dielectric layer 111 may include a barium titanate-based compound as a primary component. For example, by using the barium titanate-based compound as a dielectric base material, dielectric characteristics of the multilayer ceramic capacitor 100 may be secured.

The barium titanate-based compound may include at least one selected from the group consisting BaTiO₃, BaZrO₃, BaSnO₃, CaTiO₃, CaZrO₃, CaSnO₃, SrTiO₃, SrZrO₃, and SrSnO₃, or the like. These may be used alone or in combination of two or more.

The dielectric layer 111 may further include a secondary component.

The secondary component may include at least one selected from the group consisting manganese (Mn), chromium (Cr), silicon (Si), aluminum (AI), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V), or the like. These may be used alone or in combination of two or more.

According to an example, the average thickness (average length in the T-axis direction) of the dielectric layer 111 may be about 1.0 μm to 8.0 μm. According to another example, the average thickness (average length in the T-axis direction) of the dielectric layer 111 may be 2 μm to 6 μm. In the above ranges, reliability of the multilayer ceramic capacitor 100 may be further improved.

For example, the average thickness of the dielectric layer 111 may be based on a central point of the dielectric layer 111 in the length direction (L-axis direction) or the width direction (W-axis direction), in a SEM analysis image of a cross-section (L-T cross-section) taken along the length direction (L-axis direction) and the stacking direction (T-axis direction) to be perpendicular to the width direction at a center of the multilayer ceramic capacitor 100 in the width direction (W-axis direction), and may be obtained as an arithmetic average value of thicknesses of the dielectric layer 111 measured at 10 points away from the reference point by a predetermined interval. The interval of the 10 points may be adjusted depending on the scale of the SEM image, and for example, may be an interval of 1 μm to 100 μm, 1 μm to 50 μm, or 1 μm to 10 μm. At this time, all the 10 points must be located within the dielectric layer 111, and when all the 10 points are not located within the dielectric layer 111, the location of the reference point may be changed, or the interval between the 10 points may be adjusted.

The first internal electrode 121 and the second internal electrode 122 of the internal electrode layers 121 and 122 may have a different polarity. For example, the first internal electrode 121 and the second internal electrode 122 may be alternately disposed to face each other along the T-axis direction interposing the dielectric layer 111. For example, a first end of the first internal electrode 121 may be exposed through the third surface of the capacitor body 110, and a first end of the second internal electrode 122 may be exposed through a fourth surface of the capacitor body 110.

The first internal electrode 121 and the second internal electrode 122 may be electrically insulated by the dielectric layer 111 disposed therebetween.

An end portion of the first internal electrode 121 exposed through the third surface of the capacitor body 110 may be electrically connected to the first external electrode 131. For example, an end portion of the second internal electrode 122 exposed through the fourth surface of the capacitor body 110 may be electrically connected to the second external electrode 132.

The first internal electrode 121 and the second internal electrode 122 may include a conductive metal, respectively. For example, the conductive metal may include a metal selected from the croup consisting of such as Ni, Cu, Ag, Pd, and Au, or an alloy thereof (e.g., Ag—Pd alloy).

The first internal electrode 121 and the second internal electrode 122 may include dielectric particles of the same composition as the ceramic material included in the dielectric layer 111.

The first internal electrode 121 and the second internal electrode 122 may be formed by using a conductive paste including a conductive metal. For example, the conductive paste may be printed through a screen printing or gravure printing method.

According to an example, an average thickness of the first internal electrode 121 and the second internal electrode 122 may be 0.1 μm to 2 μm. In the above range, the resistance may be further reduced as the multilayer ceramic capacitor 100 becomes further miniaturized and thinner.

The average thickness of the first internal electrode 121 and the second internal electrode 122 may be measured by the SEM analysis. The SEM analysis may be substantially the same the above-described method for measuring the average thickness of the dielectric layer 111.

The capacitor body 110 may be formed by firing a laminate in which the plurality of dielectric layers 111 and the internal electrode layers 121 and 122 are stacked.

Referring to FIG. 2, the first external electrode 131 and the second external electrode 132 may have a different polarity.

The first external electrode 131 may be in contact with and electrically connected to a portion where the first internal electrode 121 is exposed. For example, the second external electrode 132 may be in contact with and electrically connected to a portion where the second internal electrode 122 is exposed.

When a predetermined voltage is applied to the first external electrode 131 and the second external electrode 132, charges may be may accumulated between the first internal electrode 121 and the second internal electrode 122 facing each other. The capacitance of the multilayer ceramic capacitor 100 may be proportional to an overlapping area in a plan view of the first internal electrode 121 and the second internal electrode 122 that overlap with each other in the stacking direction (T-axis direction) in the active region.

The first external electrode 131 and the second external electrode 132 may include first and second connection portions (not shown) disposed on the third surface and the fourth surface of the capacitor body 110, respectively, and connected to the first internal electrode 121 and the second internal electrode 122, respectively. The first external electrode 131 and the second external electrode 132 may include first and second band portions (not shown) disposed on edges where the third surface and the fourth surface of the capacitor body 110, the first surface and the second surface or the fifth surface and the sixth surface meet each other, respectively.

The first and second band portions may extend from the first and second connection portions to a part of the first surface and the second surface, or the fifth surface and sixth surface of the capacitor body 110, respectively. The fixing strength of the first external electrode 131 and the second external electrode 132 may be improved through the first and second band portions.

The external electrodes 131 and 132 may include electrode layers 10 and 20 located on the surface of the capacitor body 110.

The first external electrode 131 may include a first electrode layer 10 located directly on the surface (e.g., the third surface) of the capacitor body 110 and electrically connected to the first internal electrode 121. For example, the second external electrode 132 may include a second electrode layer 20 located directly on the surface (e.g., fourth surface) of the capacitor body 110 and electrically connected to the second internal electrode 122.

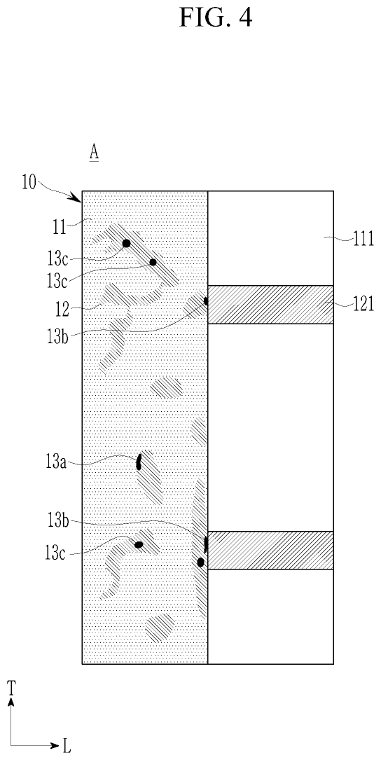

FIG. 4 is an enlarged partial cross-sectional view of the portion A of FIG. 2.

Referring to FIG. 4, the external electrodes 131 and 132 or the electrode layers 10 and 20 may include a conductive metal 11 and a glass 12. In some embodiments of the present disclosure, the glass 12 may be located dispersedly within the conductive metal 11. The conductive metal 11 and the glass 12 may be included in the electrode layers 10 and 20.

The conductive metal 11 may include at least one selected from the group consisting of copper (Cu), nickel (Ni), gold (Au), platinum (Pt), tin (Sn), tungsten (W), titanium (Ti), and lead (Pb). The conductive metal 11 may include alloy or combination of the above-described metals. The conductive metal 11 may include, for example, Cu or Cu alloy. When the conductive metal 11 includes Cu, a metal other than Cu may be included in an amount of 5 parts by mole or less per 100 parts by mole of Cu.

The glass 12 may include a composition in which oxides are mixed, and for example, may include at least one selected from the group consisting of silicon oxide, boron oxide, aluminum oxide, transition metal oxide, alkali metal oxide and alkaline-earth metal oxide.

The transition metal may include at least one selected from the group consisting of zinc (Zn), titanium (Ti), copper (Cu), vanadium (V), manganese (Mn), iron (Fe) and nickel (Ni). The alkali metal may include at least one selected from the group consisting of lithium (Li), sodium (Na) and potassium (K). The alkaline-earth metal may include at least one selected from the group consisting of magnesium (Mg), calcium (Ca), strontium (Sr) and barium (Ba).

The glass 12 may include at least one of silver (Ag) or palladium (Pd).

The glass 12 may include a first interface region in contact with the conductive metal 11. The first interface region may be defined as a region of a depth of 500 nm from an interface of the conductive metal 11 and the glass 12 in an inward direction of the glass 12.

The first interface region may include at least one of Ag or Pd. Accordingly, the adhesive strength between the conductive metal 11 and the glass 12 and density of the external electrodes 131 and 132 may be improved, and reliability and structural stability of the multilayer ceramic capacitor 100 may be improved.

In some embodiments, the first interface region of the glass 12 may include a region 13a including or consisting of Ag and/or Pd.

As shown in FIG. 4, at least one of Ag or Pd included in the first interface region as illustrated as 13a may be in contact with both of the conductive metal 11 and the glass 12, the adhesive strength between the conductive metal 11 and the glass 12 and the density of the external electrodes 131 and 132 may be improved.

The first interface region may further include an oxide of the conductive metal 11. Accordingly, the wetting and adhesive strength between the conductive metal 11 and the glass 12 may be further improved, and the structural stability and density of the external electrodes 131 and 132 may be further improved. For example, Ag oxide or Pd oxide included in the glass composition may be reduced, and a part of the conductive metal 11 in contact with the glass composition may be oxidized. Accordingly, oxides of the conductive metal 11 may be located in the first interface region.

In some embodiments of the present disclosure, when Cu is used as the conductive metal 11, the first interface region may include Cu oxide.

At least one 13a including Ag and/or Pd included in the first interface region may exist in the form of an alloy with the conductive metal 11. For example, Cu, and an alloy including the at least one of Ag or Pd may be located on the first interface region. Accordingly, the wetting and adhesive strength between the conductive metal 11 and the glass 12 may be further improved, and the structural stability and density of the external electrodes 131 and 132 may be further improved.

In some embodiments of the present disclosure, the glass 12 may further include a second interface region in contact with the internal electrode layers 121 and 122. The second interface region may be defined as a region of a depth of 500 nm from an interface of the glass 12 and the internal electrode layers 121 and 122 in the inward direction of the glass 12.

The second interface region may include the at least one of Ag or Pd. Accordingly, the connectivity between the glass 12 and the internal electrode layers 121 and 122 may be further improved, and the reliability and structural stability of the multilayer ceramic capacitor 100 may be further improved.

In some embodiments, second interface region of the glass 12 may include a region 13b including or consisting of Ag and/or Pd.

As shown in FIG. 4, at least one of Ag and Pd included in the second interface region as illustrated as 13b may be in contact with both of the glass 12 and the internal electrode layers 121 and 122, the connection stability and electrical reliability between the glass 12 and the internal electrode layers 121 and 122 may be further improved.

The at least one 13b including Ag and/or Pd included in the second interface region 13b may exist in the form of an alloy with constituent elements of the internal electrode layers 121 and 122. For example, Ni, and an alloy including the at least one of Ag or Pd may be located on the second interface region.

Accordingly, the connectivity and low-resistance characteristics between the glass 12 and the internal electrode layers 121 and 122 may be further improved, and the reliability and structural stability of the multilayer ceramic capacitor 100 may be further improved.

According to some example embodiments, the glass 12 may further include a central region in which a depth from the interface of the conductive metal 11 and the glass 12 in the inward direction of the glass 12 exceeds 500 nm. When the glass 12 is in contact with the internal electrode layers 121 and 122, the central region may be defined as a region in which the depth from the interface of the conductive metal 11 and the glass 12 in the inward direction of the glass 12, and a depth from the interface of the glass 12 and the internal electrode layers 121 and 122 in the inward direction of the glass 12 exceed each 500 nm.

The central region may include the at least one of Ag or Pd. Accordingly, the density and stability of the glass 12 may be further improved.

In some embodiments, the central region of the glass 12 may include a region 13c including or consisting of Ag and/or Pd.

As shown in FIG. 4, at least one 13c including Ag and/or Pd included in the central region may be located inside glass 12, as well as in the interface in contact with the exterior of the glass 12.

The first interface region, at least one of 13a, 13b, or 13c including Ag and Pd included in the second interface region and the central region may be derived from at least one selected from a group consisting of Ag oxide or Pd oxide. For example, the Ag oxide (e.g., Ag₂O) or the Pd oxide (e.g., PdO) included in the glass composition may oxidize the conductive metal 11 (e.g., Cu) and be reduced to Ag or Pd. According to the sintering, the reduced Ag and Pd may flow together with the glass 12, and according to the density difference, may be diffused from the central region to the first interface region and the second interface region. Accordingly, the adhesive strength between the above-described conductive metal 11 and the glass 12, density of the external electrodes 131 and 132, and the connectivity and low-resistance characteristics of the external electrodes 131 and 132 and the internal electrode layers 121 and 122 may be improved.

The first interface region, the second interface region, and/or the central region may further include at least one of Fe, Co, or In. By changing the input ratio of the above elements, the fluidity, dispersibility, and density of the glass 12 can be easily adjusted.

The presence and containing elements of the first interface region, the second interface region, and the central region described above of the glass 12 may be measured by performing the scanning electron microscopy-energy dispersive X-ray spectroscopy (SEM-EDS) with respect to a cross-section (L-T cross-section) taken along the length direction (L-axis direction) and the stacking direction (T-axis direction) to be perpendicular to the width direction at the center of the multilayer ceramic capacitor 100 in the width direction (W-axis direction). The multilayer ceramic capacitor 100 may be fixed by an epoxy resin, and may be polish by a polishing machine so that the L-T cross-section may be exposed. The polishing may be performed so that ½ of the length in the width direction (W-axis direction) is deleted. With respect to the exposed L-T cross-section, one to 6 rectangular regions of horizontally 40 μm and vertically 40 μm may be set so that the internal electrode layers 121 and 122 and the electrode layers 10 and 20 may be included, and the SEM analysis images may be obtained with respect to the rectangular regions, respectively. The SEM-EDS analysis result of each of the glasses 12 may be obtained by increasing the analysis magnification to 5k or more with respect to the SEM analysis images, and performing the EDS mapping analysis and point/line scan. In the SEM-EDS analysis image, the brightness of the region where Ag and/or Pd exist may be represented to be relatively high. By averaging the SEM-EDS analysis results of the glasses 12 included in the entire rectangular regions, information (position, content, or the like) on elements (e.g., Ag and/or Pd) included in the first interface region, the second interface region, and the central region of the glass 12 may be obtained.

The presence of oxides and containing elements of the above-described conductive metal 11 may be measured by performing the transmission electron microscope-energy dispersive X-ray spectroscopy (TEM-EDS). With respect to the L-T cross-section, 10 or more rectangular regions of horizontally 20 μm and vertically 20 μm may be set, and TEM analysis images may be obtained with respect to the rectangular regions, respectively. By performing the EDS mapping analysis and point/line scan of the rectangular region (horizontally 20 μm and vertically 20 μm or less) for which the analysis magnification is increased to 5k or more with respect to the TEM analysis images, the presence of oxides and the content of constituent elements of the conductive metal 11 may be measured, respectively. By averaging all measurement results, the presence and the content of oxide of the conductive metal 11 included in the first interface region may be measured.

In addition to Ag and Pd, the glass 12 may further include at least one selected from the group consisting of Si, Al, Fe, Sn, Zn, Li, Na, K, Ba, Ca, Sr, B, Ni, Mn, Ge, Cu, In, Co, Ti, and P, or the like. These may be used alone or in combination of two or more.

An average particle diameter D50 of the glass 12 may be 0.1 μm to 10 μm. In the above range, Ag and/or Pd may be sufficiently included in the first interface region and the second interface region described above, and adhesive strength and connectivity may be further improved. D50 of the glass 12 may be calculated by measuring at least 100 maximum major axes of the particles of the glass 12 in in the SEM analysis image of the L-T cross-section and creating a size distribution accumulative curve. D50 represents the size at a point where it becomes 50% on the size distribution accumulative curved line.

According to some example embodiments, the external electrodes 131 and 132 may further include plating layers 30 and 40 disposed on the electrode layers 10 and 20.

The external electrodes 131 and 132 may further include, optionally, a conductive resin layer (not shown) located between the electrode layers 10 and 20 and the plating layers 30 and 40, respectively.

The conductive resin layer may extend to the first surface and the second surface, or the fifth surface and the sixth surface of the capacitor body 110. In this case, a length of a region (e.g., band portion) where the conductive resin layer is disposed may be longer than a length of a region (e.g., band portion) where the electrode layers 10 and 20 are disposed to extend to the first surface and the second surface, or the fifth surface and the sixth surface of the capacitor body 110. For example, the conductive resin layer may entirely cover the electrode layers 10 and 20.

The conductive resin layer may include a resin and a conductive member.

The resin is not particularly limited, if it has bondability and shock absorbing properties and is capable of being mixed with the conductive member powder to create a paste, and may include, for example, a phenol resin, an acryl resin, a silicone resin, an epoxy resin, or a polyimide resin.

The conductive member may be electrically connected to the internal electrode layers 121 and 122 or the electrode layers 10 and 20.

The conductive member may have a spherical shape, a flake shape, or a combination thereof. For example, the conductive member may be formed only in the flake shape or only in the spherical shape, and may include a mixed shape of the flake shape and the spherical shape.

The spherical shape may include a shape that is not perfectly spherical shape, and for example, may include a shape in which a length ratio of a major axis and a minor axis (i.e., major axis/minor axis) is less than or equal to 1.45. The flake-shaped powder refers to a powder having a flat and elongated shape, and for example, a length ratio of a major axis and a minor axis (i.e., major axis/minor axis) may be greater than or equal to 1.95, although not limited thereto.

The external electrodes 131 and 132 may further include the plating layers 30 and 40 disposed to cover the above-described conductive resin layer.

The plating layers 30 and 40 may include a first plating layer 30 disposed on the first electrode layer 10 and a second plating layer 40 disposed on the second electrode layer 20.

The plating layers 30 and 40 may include at least one selected from the group consisting of nickel (Ni), copper (Cu), tin (Sn), palladium (Pd), platinum (Pt), gold (Au), silver (Ag), tungsten (W), titanium (Ti), lead (Pb), and an alloy thereof, or the like. These may be used alone or in combination of two or more.

The plating layers 30 and 40 may be a nickel (Ni) plating layer or a tin (Sn) plating layer. For example, the plating layers 30 and 40 may include the form in which a nickel (Ni) plating layer and a tin (Sn) plating layer are sequentially stacked or the form in which a tin (Sn) plating layer, a nickel (Ni) plating layer, and a tin (Sn) plating layer are sequentially stacked. For example, the plating layers 30 and 40 may include a plurality of nickel (Ni) plating layers and/or a plurality of tin (Sn) plating layers.

Through the plating layers 30 and 40, mountability on a substrate, structural reliability, durability against external impact, heat resistance, and equivalent series resistance (ESR) of the multilayer ceramic capacitor 100 may be improved.

Hereinafter, a method for preparing the multilayer ceramic capacitor 100 according to still another example will be described.

A method for preparing the multilayer ceramic capacitor 100 may include manufacturing the capacitor body 110 including the dielectric layer 111 and internal electrodes 121 and 122, and forming the external electrodes 131 and 132 on the outer side of the capacitor body 110.

In the manufacturing process of the capacitor body 110, a dielectric paste that becomes the dielectric layer 111 after firing and a conductive paste that becomes the internal electrodes 121 and 122 after firing may be prepared.

A calcined powder may be obtained by uniformly mixing and drying the dielectric powder through wet mixing or the like, and then by heat-treating under a predetermined condition. The dielectric paste may be manufactured by adding an organic vehicle or aqueous vehicle into the calcined powder and heating and mixing them.

The dielectric paste may be formed into a sheet by a technique such as a doctor blade method, to obtain the dielectric green sheet. For example, the dielectric paste may include an additive selected from various dispersants, a plasticizer, a dielectric material, a secondary component compound, glass, and/or the like.

The conductive paste for an internal electrode may be prepared by mixing a conductive powder made of a conductive metal or an alloy thereof with a binder or solvent.

The conductive paste for an internal electrode may include indium (In).

The conductive paste for an internal electrode may include ceramic powder (e.g., barium titanate powder) as a co-material. The co-material may inhibit sintering of the conductive powder during the firing process.

The conductive paste for an internal electrode may be applied to the dielectric green sheet surface in a predetermined pattern by using various printing methods such as screen printing or a transfer method. The dielectric green sheet laminate may be obtained by stacking dielectric green sheets having internal electrode patterns in a plurality of layers and by pressurizing it in the stacking direction. The dielectric green sheet and the internal electrode pattern may be stacked so that the dielectric green sheet may be located on an upper surface and a lower surface of the dielectric green sheet laminate in the stacking direction.

Optionally, the dielectric green sheet laminate may be cut to a predetermined size by dicing or the like.

The dielectric green sheet laminate may be solidified and dried to remove plasticizers or the like, if necessary, and after solidifying and drying, may be barrel polished by using horizontal centrifugal barrel machine, or the like. In the barrel polishing, the dielectric green sheet laminate is placed into a barrel container together with media and polishing liquid, and rotational motion, vibration, or the like is applied to the barrel container, to polish unnecessary portions such as burr generated during cutting. For example, after the barrel polishing, the dielectric green sheet laminate may be washed with a cleaning solution such as water and dried.

The dielectric green sheet laminate may be subjected to binder removal treatment and firing treatment, to obtain the capacitor body 110.

The conditions for the binder removal treatment may be appropriately adjusted according to the composition of the primary component of the dielectric layer or the composition of the primary component of the internal electrode. For example, at the time of the binder removal treatment, the temperature increasing rate may be 5° C./hour to 300° C./hour, the support temperature may be 180° C. to 400° C., and the temperature maintaining time may be 0.5 hours to 24 hours. The binder removal atmosphere may be air or a reducing atmosphere.

The conditions for the firing treatment may be appropriately adjusted according to the composition of the primary component of the dielectric layer or the composition of the primary component of the internal electrode. For example, the temperature during firing may be 1200° C. to 1350° C., or 1220° C. to 1300° C., and the time may be 0.5 hours to 8 hours, or 1 hour to 3 hours. The firing atmosphere may be a reducing atmosphere, and for example, an atmosphere of a humidified mixture of nitrogen gas (N2) and hydrogen gas (H2). When the internal electrodes 121 and 122 include nickel (Ni) or nickel (Ni) alloy, the oxygen partial pressure in firing atmosphere may be 1.0×10⁻¹⁴ MPa to 1.0×10⁻¹⁰ MPa.

After the firing treatment, annealing may be performed if necessary. The annealing is a treatment for re-oxidizing the dielectric layer, and the annealing may be performed in the case that the firing treatment was performed in a reducing atmosphere. The conditions for the annealing treatment may also be appropriately adjusted according to the composition of the primary component of the dielectric layer or the like. For example, the temperature at the time of annealing may be 950° C. to 1150° C., the time may be 0 hours to 20 hours, and temperature increasing rate may be 50° C./hour to 500° C./hour. The annealing atmosphere may be a humidified nitrogen gas N2 atmosphere, and oxygen partial pressure may be 1.0×10⁻⁹ MPa to 1.0×10⁻⁵ MPa.

In the binder removal treatment, the firing treatment, or the annealing treatment, in order to humidify nitrogen gas, mixed gas, or the like, for example, a wetter or the like may be used, and in this case, the water temperature may be 5° C. to 75° C. The binder removal treatment, the firing treatment, and the annealing treatment may be consecutively performed, and may be independently performed.

Optionally, the third surface and the fourth surface of the obtained capacitor body 110 may be subjected to surface treatment such as sandblasting treatment, laser irradiation, or barrel polishing. Through such surface treatment, end portions of the first internal electrode 121 and the second internal electrode 122 may be exposed on the surface of the third surface and fourth surface. Accordingly, the electrical junction between the first external electrode 131 and the second external electrode 132 and the first internal electrode 121 and the second internal electrode 122 may be improved, and the alloy portion may be easily formed.

By forming the electrode layers 10 and 20 by applying a paste for forming an electrode layer on an outer surface of the capacitor body 110 and sintering it, the external electrodes 131 and 132 may be manufactured.

The paste for forming an electrode layer may include the conductive metal 11 and the glass composition. The glass 12 may be formed as the glass composition is fired.

The glass composition may include at least one selected from a group consisting of Ag oxide and Pd oxide. In an example, Ag oxide may include Ag₂O. In an example, Pd oxide may include PdO.

The Ag oxide and/or Pd oxide may oxidize a part of the conductive metal 11 in contact with the glass composition through sintering, to be reduced to Ag and Pd. According to the sintering, the reduced Ag and Pd may flow together with the glass 12, and according to the density difference, may be diffused from the central region to the first interface region and the second interface region. Accordingly, the adhesive strength between the above-described conductive metal 11 and the glass 12, density of the external electrodes 131 and 132, and the connectivity and low-resistance characteristics of the external electrodes 131 and 132 and the internal electrode layers 121 and 122 may be improved.

The content of the at least one selected from a group consisting of Ag oxide and Pd oxide among the total weight of the glass composition may be 0.01 wt % to 15 wt %. In the above range, Ag and/or Pd may be sufficiently formed, so that the above-described adhesive strength, electrode density, connectivity and low-resistance characteristics may be further improved, and the fluidity and dispersibility of the glass 12 may be further improved.

The glass composition may further include at least one selected from a group consisting of Si oxide, Al oxide, Fe oxide, Sn oxide, Zn oxide, Li oxide, Na oxide, K oxide, Ba oxide, Ca oxide, Sr oxide, B oxide, Ni oxide, Mn oxide, Ge oxide, Cu oxide, In oxide, Co oxide, Ti oxide, and P oxide.

For example, the glass composition may further include at least one selected from the group consisting of Li₂O, Na₂O, K₂O, SiO₂, Al₂O₃, FeO, Fe₂O₃, Fe₃O₄, NiO, Ni₂O₃, Ni₃O₄, In₂O₃, TiO₂, P₂O₅, BaO, CaO, SrO, B₂O₃, ZnO, SnO, SnO₂, Cu₂O, CuO, CoO, Co₂O₃, GeO₂, MnO, Mn₂O, Mn₂O₃, and Mn₃O₄, or the like. These may be used alone or in combination of two or more.

The glass composition may include, Si oxide in 5 parts by weight to 20 parts by weight, Al oxide in 5 parts by weight to 15 parts by weight, Fe oxide in 0.01 parts by weight to 15 parts by weight, Sn oxide in 0.01 parts by weight to 15 parts by weight, Zn oxide in 1 part by weight to 15 parts by weight, Li oxide in 10 parts by weight to 25 parts by weight, Na oxide in 10 parts by weight to 25 parts by weight, K oxide in 10 parts by weight to 25 parts by weight, Ba oxide in 15 parts by weight to 45 parts by weight, Ca oxide in 15 parts by weight to 45 parts by weight, Sr oxide in 15 parts by weight to 45 parts by weight, B oxide in 15 parts by weight to 25 parts by weight, Ni oxide in 0.01 parts by weight to 15 parts by weight, Mn oxide in 0.01 parts by weight to 15 parts by weight, Ge oxide in 0.01 parts by weight to 15 parts by weight, Cu oxide in 0.01 parts by weight to 15 parts by weight, In oxide in 0.01 parts by weight to 15 parts by weight, Co oxide in 0.01 parts by weight to 15 parts by weight, Ti oxide in 0.01 parts by weight to 15 parts by weight, and P oxide in 0.01 parts by weight to 15 parts by weight with respect to a total amount (100 parts by weight) of the glass composition.

The glass 12 may be prepared by mixing the components of the glass composition, heat-treating them at predetermined temperature or higher, quenching them, and then atomizing them, or by using a gaseous, liquid, or spray pyrolysis method, or the like.

The glass composition may be included in an amount of 1 part by weight to 40 parts by weight based on 100 parts by weight of the conductive metal 11, and for example, may be included in an amount of 5 parts by weight to 35 parts by weight.

The paste for forming an electrode layer may further include a binder, a solvent, a dispersant, a plasticizer, oxide powder, or the like.

The binder may include, for example, ethylcellulose, acryl, butyral, or the like, and the solvent may include, for example, an organic solvent or an aqueous solvent, such as terpineol, butylcarbitol, alcohol, methyl ethyl ketone, acetone, and toluene.

As a method of applying the paste for forming an electrode layer to the outer surface of the capacitor body 110, a dip method, various printing methods such as screen printing, a coating method using dispenser or the like, a spraying method using a spray or the like, or the like may be used. The paste for forming an electrode layer may be applied to at least the third surface and the fourth surface of the capacitor body 110, and optionally, may also be applied to a part of the first surface, the second surface, the fifth surface, or the sixth surface where band portions of the first external electrode and the second external electrode are formed.

The sintering may be performed at a temperature of 400° C. to 900° C. In the above range, Ag oxide and/or Pd oxide of the glass 12 may be sufficiently reduced, and Ag and Pd may sufficiently move to the above-described first interface region, or the first interface region and the second interface region.

Subsequently, optionally, a paste for forming a conductive resin layer is applied to the outer surface of the capacitor body 110 where the electrode layers 10 and 20 are formed and then cured, to form the conductive resin layer.

The paste for forming a conductive resin layer may include a resin, and optionally, a conductive metal or a non-conductive filler. The description of the conductive metal and resin is the same as described above, and the repeated description will not be included here again. In addition, the paste for forming a conductive resin layer may optionally include a binder, a solvent, a dispersant, a plasticizer, oxide powder, or the like. The binder may include, for example, ethylcellulose, acryl, butyral, or the like, and the solvent may include an organic solvent or an aqueous solvent, such as terpineol, butylcarbitol, alcohol, methyl ethyl ketone, acetone, and toluene.

According to some example embodiments, the conductive resin layer may be formed by dipping the capacitor body 110 into the paste for forming a conductive resin layer and then curing it, or by printing the paste for forming a conductive resin layer on the surface of the capacitor body 110 by a screen printing or gravure printing method or the like, or by applying the paste for forming a conductive resin layer to the surface of the capacitor body 110 and then curing it.

The plating layers 30 and 40 may be formed on outer side of the conductive resin layer.

The plating layers 30 and 40 may be formed by a plating method, and may be formed by sputtering or electric deposition.

Hereinafter, specific examples of the present disclosure will be presented.

However, the examples described below are merely for exemplification or description.

### Examples 1 to 11

### (Preparation of Glass Composition)

A glass composition was formed to have the composition of the following Table 1.

TABLE 1

| Component | Content (wt %) |
|---|---|
| Li₂O | 10 |
| SiO₂ | 10 |
| Al₂O₃ | 10 |
| FeOₓ (FeO, Fe₂O₃, Fe₃O₄) | 2 |
| NiOₓ(NiO, Ni₂O₃, Ni₃O₄) | 5 |
| Ag₂O | 1 |
| PdO | 1 |
| In₂O₃ | 1 |
| TiO₂ | 1 |
| P₂O₅ | 1 |
| BaO | 25 |
| B₂O₃ | 20 |
| ZnO | 5 |
| SnOₓ(SnO, SnO₂) | 1 |
| CuOₓ(Cu₂O, CuO) | 2 |
| CoOₓ(CoO, Co₂O₃) | 2 |
| GeO₂ | 1 |
| MnOₓ(MnO, Mn₂O, Mn₂O₃, Mn₃O₄) | 2 |

### (Preparation of Multilayer Ceramic Capacitor)

After preparing the dielectric green sheet by using barium titanate (BaTiO₃) as the primary component powder, the conductive paste layer including Ni is printed on the surface of the dielectric green sheet, and the dielectric green sheet (Width×Depth×Height=3.2 mm×2.5 mm×2.5 mm) where the conductive paste layer is formed is stacked and squeezed, to prepare the dielectric green sheet laminate. The dielectric green sheet laminate was subjected to a plasticizing process at 400° C. or lower in a nitrogen atmosphere, and then fired under the conditions of a firing temperature of 1300° C. or less and a hydrogen concentration 1.0% H₂ or less, to prepare a capacitor body.

A paste for forming an electrode layer was prepared by mixing 100 parts by weight of Cu, 10 parts by weight of the glass composition, and 8 parts by weight of acryl-based binder.

The paste for forming an electrode layer was applied to the outer surface of the capacitor body and dried, and then, as shown in the following Table 2, sintered at 400° C. to 900° C., to form the electrode layer of the external electrode. Subsequently, a Ni plating layer and a Sn plating layer were sequentially formed on the surface of the electrode layer, to prepare the multilayer ceramic capacitor.

### Comparative Examples 1 to 11

### (Preparation of Glass Composition)

The glass composition was prepared in the same method as Example 1, except that Ag₂O and PdO were not added.

### (Preparation of Multilayer Ceramic Capacitor)

The multilayer ceramic capacitor of Comparative Examples 1 to 11 was prepared in the same method as Examples 1 to 11, respectively, except that the glass composition was used.

### Evaluation 1: SEM-EDS Analysis (Ag, Pd)

The multilayer ceramic capacitors according to the above-described Examples and Comparative Examples were laid down horizontally, and the area around the multilayer ceramic capacitor was fixed with epoxy resin.

Polishing was performed by a polishing machine so that a cross-section (L-T cross-section) taken along the length direction (L-axis direction) and stacking direction (W-axis direction) to be perpendicular to the width direction at a center of the multilayer ceramic capacitor in the width direction (W-axis direction) may be exposed.

With respect to the exposed L-T cross-section, three rectangular regions of horizontally 40 μm and vertically 40 μm were set to include the internal electrode layer and electrode layer, and SEM photographing with respect to the rectangular regions were performed, respectively, to obtain three SEM analysis images. The SEM photographing were performed by using a Verios G4 from Thermofisher Scientific under an accelerating voltage of 200 kV.

By performing the EDS mapping analysis and the point scan with respect to the SEM analysis images, respectively, the presence and contents of Ag and Pd elements in a region (first interface region) where glass and copper are in contact were measured to be indicated in brightness. By averaging the brightness measured from the images, it was evaluated as the brightness of Ag and Pd elements.

In the mapping analysis image, it was evaluated that the higher the brightness observed by human eyes in the Ag and Pd element portions, the greater the content of the Ag and Pd elements, and the lower the brightness, the smaller the content of the Ag and Pd elements. Specifically, the measurement results were evaluated as follows.
⊚: 80% to 100% of the observed maximum brightness
∘: 50% or more and less than 80% of the observed maximum brightness
Δ: more than 0% and less than 50% of the observed maximum brightness
X: Ag and Pd elements were not observed

### Evaluation 2: TEM-EDS Analysis (Cu Oxide)

The multilayer ceramic capacitors according to the above-described Examples and Comparative Examples were laid down horizontally, and the area around the multilayer ceramic capacitor was fixed with epoxy resin.

Polishing was performed by a polishing machine so that a cross-section (L-T cross-section) taken along the length direction (L-axis direction) and stacking direction (W-axis direction) to be perpendicular to the width direction at a center of the multilayer ceramic capacitor in the width direction (W-axis direction) may be exposed.

With respect to the exposed L-T cross-section, 10 rectangular regions of horizontally 20 μm and vertically 20 μm were set to include the interface of glass and copper, and TEM photographing was performed with respect to the rectangular regions, respectively, to obtain ten TEM images. The TEM photographing was performed by using a Xe-FIB equipment under an acceleration voltage of 20 kV.

By performing the EDS mapping analysis and the point scan with respect to the TEM analysis images, respectively, the presence and content of Cu oxide in a region (first interface region) where glass and copper are in contact were measured. By averaging the content of Cu oxide Included in all TEM analysis images, it was evaluated as the content of Cu oxide.

In more detail, the measurement results was evaluated as follows.
⊚: 80% to 100% of the measured maximum content
∘: 50% or more and less than 80% of the measured maximum content
Δ: more than 0% and less than 50% of the measured maximum content
X: Cu oxide was not measurement or observed

### Evaluation 3: Moisture Resistance Reliability

With respect to the multilayer ceramic capacitors according to the above-described Examples and Comparative Examples, the moisture resistance reliability was evaluated by measuring the change of insulation resistance (IR) for 10 hours by using the ESPEC (PR-3J, 8585) equipment under the condition of 85° C., relative humidity 85%, and 12 V.

In more detail, the measurement results was evaluated as follows.
⊚: the measured IR value is greater than 1.0×10⁷ Ω
∘: the measured IR value is greater than 1.0×10⁶ (and less than or equal to 1.0×10⁷ Ω
Δ: the measured IR value is greater than 1.0×10⁵ Ω and less than or equal to 1.0×10⁶ Ω
X: the measured IR value is less than 1.0×10⁵ Ω

The sintering temperature and evaluation results of the conductive paste for an electrode are represented in the following Table 2.

TABLE 2

| | Sintering | | | Moisture |
|---|---|---|---|---|
| | temperature | Ag, | Cu | resistance |
| | (° C.) | Pd | oxide | reliability |
| Example 1 | 400 | ⊚ | Δ | Δ |
| Example 2 | 450 | ⊚ | ◯ | Δ |
| Example 3 | 500 | ⊚ | ⊚ | Δ |
| Example 4 | 550 | ⊚ | ⊚ | ◯ |
| Example 5 | 600 | ⊚ | ⊚ | ◯ |
| Example 6 | 650 | ⊚ | ⊚ | ⊚ |
| Example 7 | 700 | ⊚ | ⊚ | ⊚ |
| Example 8 | 750 | ◯ | ⊚ | ⊚ |
| Example 9 | 800 | ◯ | ⊚ | ⊚ |
| Example 10 | 850 | ◯ | ◯ | ◯ |
| Example 11 | 900 | ◯ | ◯ | ◯ |
| Comparative Example 1 | 400 | X | X | X |
| Comparative Example 2 | 450 | X | X | X |
| Comparative Example 3 | 500 | X | X | X |
| Comparative Example 4 | 550 | X | X | X |
| Comparative Example 5 | 600 | X | X | X |
| Comparative Example 6 | 650 | X | X | X |
| Comparative Example 7 | 700 | X | X | X |
| Comparative Example 8 | 750 | X | X | X |
| Comparative Example 9 | 800 | X | X | X |
| Comparative Example 10 | 850 | X | X | X |
| Comparative Example 11 | 900 | X | X | X |

Referring to Table 2, in the Examples where the first interface region in contact with the conductive metal of the glass includes at least one of Ag or Pd, the density and structural stability of the external electrode, and the connectivity and moisture resistance reliability of the external electrode and the internal electrode were relatively improved, compared to Comparative Examples.

### Evaluation 4: Equivalent Series Resistance (ESR) Evaluation

Samples were prepared, where 40 multilayer ceramic capacitors according to Example 7 and Comparative Example 7 were welded to an aluminum belt to prepare each sample. However, the sintering temperature of Example 7 and Comparative Example 7 was adjusted to 730° C. for this evaluation. The ESR was measure with respect to the sample by using the E4980A model of KEYSIGHT under the condition of 100 kHz and 1.5±0.5V.

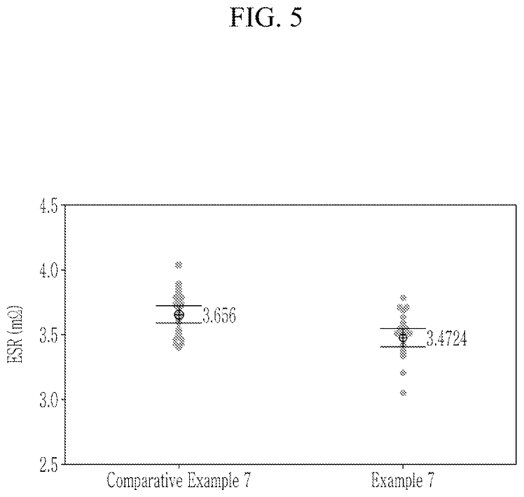

FIG. 5 is a graph showing the ESR of the multilayer ceramic capacitor according to Example 7 and Comparative Example 7.

Referring to FIG. 5, the ESR of the multilayer ceramic capacitor according to Example 7 was 3.4724 mΩ, and the ESR of the multilayer ceramic capacitor according to Comparative Example 7 was 3.656 mΩ.

In Example 7 where the first interface region in contact with the conductive metal of the glass includes at least one of Ag or Pd, the low-resistance characteristics was relatively improved, compared to Comparative Example 7 sintered at the same temperature.

### DESCRIPTION OF SYMBOLS

10: first electrode layer
11: conductive metal
12: glass
13a: at least one of Ag or Pd included in first interface region
13b: at least one of Ag or Pd included in second interface region
13c: at least one of Ag or Pd included in central region
20: second electrode layer
30: first plating layer
40: second plating layer
100: multilayer ceramic capacitor
110: capacitor body
111: dielectric layer
121: first internal electrode
121: second internal electrode
131: first external electrode
132: second external electrode

What is claimed is:

1. A multilayer ceramic capacitor, comprising:
a capacitor body comprising a dielectric layer and an internal electrode layer; and
an external electrode located on an outer surface of the capacitor body, and comprising a conductive metal and glass,
wherein the glass comprises a first interface region in contact with the conductive metal, and
wherein the first interface region comprises at least one of Ag or Pd.

2. The multilayer ceramic capacitor of claim 1, wherein the first interface region is a region of a depth of 500 nm from an interface of the conductive metal and the glass in an inward direction of the glass.

3. The multilayer ceramic capacitor of claim 1, wherein the glass further comprises a second interface region in contact with the internal electrode layer, and the second interface region comprises the at least one of Ag or Pd.

4. The multilayer ceramic capacitor of claim 3, wherein the second interface region is a region of a depth of 500 nm from an interface of the glass and the internal electrode layer in an inward direction of the glass.

5. The multilayer ceramic capacitor of claim 3, wherein the second interface region comprises an alloy comprising Ni, and at least one of Ag or Pd.

6. The multilayer ceramic capacitor of claim 3, wherein the second interface region further comprises at least one of Fe, Co, or In.

7. The multilayer ceramic capacitor of claim 1, wherein the first interface region further comprises oxide of the conductive metal.

8. The multilayer ceramic capacitor of claim 1, wherein the first interface region comprises the conductive metal, and an alloy comprising at least one of Ag or Pd.

9. The multilayer ceramic capacitor of claim 1, wherein the glass further comprises a central region in which a depth from an interface of the conductive metal and the glass in an inward direction of the glass exceeds 500 nm, and the central region comprises the at least one of Ag or Pd.

10. The multilayer ceramic capacitor of claim 9, wherein the central region further comprises at least one of Fe, Co, or In.

11. The multilayer ceramic capacitor of claim 1, wherein the glass further comprises at least one selected from the group consisting of Si, Al, Fe, Sn, Zn, Li, Na, K, Ba, Ca, Sr, B, Ni, Mn, Ge, Cu, In, Co, Ti, and P.

12. The multilayer ceramic capacitor of claim 1, wherein:
the external electrode comprises an electrode layer electrically connected to the internal electrode layer and located on an end surface of the capacitor body; and
the electrode layer comprises the conductive metal and the glass.

13. The multilayer ceramic capacitor of claim 1, wherein the conductive metal comprises at least one selected from the group consisting of Cu, Ni, Au, Pt, Sn, W, Ti and Pb.

14. A multilayer ceramic capacitor, comprising:
a capacitor body comprising a dielectric layer and an internal electrode layer; and
an external electrode located on an outer surface of the capacitor body, and comprising a conductive metal including Cu or glass,
wherein the glass comprises at least one of Ag or Pd.

15. The multilayer ceramic capacitor of claim 14, wherein the glass comprises a first interface region in contact with the conductive metal, and the first interface region comprises the at least one of Ag or Pd.

16. The multilayer ceramic capacitor of claim 14, wherein the glass further comprises a second interface region in contact with the internal electrode layer, and the second interface region comprises the at least one of Ag or Pd.

17. The multilayer ceramic capacitor of claim 14, wherein the glass further comprises a central region in which a depth from an interface of the conductive metal and the glass in an inward direction of the glass exceeds 500 nm, and the central region comprises the at least one of Ag or Pd.

18. A method of preparing a multilayer ceramic capacitor, the method comprising:
applying a paste for forming an electrode layer comprising a conductive metal and a glass composition on a first surface of a capacitor body comprising a dielectric layer and an internal electrode layer; and
forming the electrode layer of an external electrode by sintering the paste for forming an electrode layer,
wherein the glass composition comprises at least one selected from a group consisting of Ag oxide and Pd oxide.

19. The method of claim 18, wherein a content of the at least one selected from a group consisting of Ag oxide and Pd oxide among a total weight of the glass composition is 0.01 wt % to 15 wt %.

20. The method of claim 18, wherein the glass composition further comprises at least one selected from a group consisting of Si oxide, Al oxide, Fe oxide, Sn oxide, Zn oxide, Li oxide, Na oxide, K oxide, Ba oxide, Ca oxide, Sr oxide, B oxide, Ni oxide, Mn oxide, Ge oxide, Cu oxide, In oxide, Co oxide, Ti oxide, and P oxide.
